(19) United States
(12) Patent Application Publication
(10) Pub. No.: US 2005/0100778 A1
(43) Pub. Date: May 12, 2005

(54) Membrane electrode assembly, manufacturing process therefor and direct type fuel cell therewith

(76) Inventors: Kunihiko Shimizu, Miyagi (JP); Toshihiko Nishiyama, Miyagi (JP); Takashi Mizukoshi, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/979,446

(22) Filed: Nov. 2, 2004

(30) Foreign Application Priority Data
Nov. 11, 2003 (JP) 2003-380606

(51) Int. Cl. H01M 4/86; H01M 4/96; H01M 4/88; H01M 8/10

(52) U.S. Cl. 429/40; 429/44; 429/42; 502/101; 429/30

(57) ABSTRACT

This invention relates to a membrane electrode assembly comprising a fuel electrode, an air electrode and an electrolyte membrane where micropores in a porous membrane is filled with a proton conducting polymer, wherein on at least one side of the electrolyte membrane is formed a planarizing layer, via which a fuel electrode or air electrode is formed, as well as a direct type fuel cell therewith.

### BACKGROUND OF THE INVENTION

1. Field of the Invention

This invention relates to a fuel cell, in particular to a membrane electrode assembly, a manufacturing process therefor and a direct type fuel cell therewith.

2. Description of the Related Art

FIG. 2 is a schematic cross-sectional view of a membrane electrode assembly (MEA) used in a conventional wet direct type fuel cell. In this figure, 1 is an alcohol fuel, 2 is a fuel-electrode side catalyst layer, 4 is a porous polymer membrane, 5 is a part filled with a proton conducting polymer, and 7 is an air-electrode side catalyst layer. A wet direct type fuel cell comprising such a membrane electrode assembly (MEA) as a unit has properties suitable as a small and portable fuel cell.

It is well-known that in a wet type ion-conducting polymer electrolyte membrane generally operated in a fuel cell at a temperature of 100° C. or less, proton conductivity becomes higher as the number of an anionic group such as a sulfonic acid group is increased in the polymer side chain.

However, a polymer electrolyte membrane having an ionic group in its side chain has a drawback that since the ionic group is also hydrophilic, an increased number of such ionic groups may lead to a more hydrated polymer electrolyte membrane, whose volume tends to be varied due to swelling, resulting in a weaker polymer electrolyte membrane.

There is also a problem that swelling of a polymer electrolyte membrane with water may increase proton transferring paths to improve proton conductivity while allowing an alcohol as a fuel to more easily penetrate the electrolyte membrane. The problem is called “crossover”, where a fuel penetrates an electrolyte membrane and reacts with an air electrode, i.e., a chemical short-circuit reaction, leading to reduction in a battery output.

These problems may be solved by use a thicker electrolyte membrane for reducing penetration by an alcohol to ensure a mechanical strength. It, however, leads to increase in an electrolyte membrane resistance.

There has been disclosed a method for ensuring a mechanical strength of an electrolyte membrane by adding a non-proton conductive reinforcing material represented by polytetrafluoroethylene (hereinafter, referred to as “PTFE”) or crosslinking electrolyte polymers. For example, JP-H06-275301-A has disclosed a solid polymer electrolyte type fuel cell comprising an ion exchange membrane consisting of a cross-linked perfluorocarbon polymer having a sulfonic acid group.

These methods, however, also have a drawback that mobility of protons is reduced, resulting in increase in an specific resistance of an electrolyte membrane per a unit thickness even when a thickness of the electrolyte membrane can be reduced.

To solve the above problem, there has been disclosed an electrolyte membrane wherein a proton conductive material is filled in an non-proton conductive porous membrane having good mechanical strength. Mechanical strength can be ensured by the porous polymer membrane as a base and proton conductivity can be ensured by the proton conductive material filled within micropores in the porous membrane. In such an electrolyte membrane, the number of a sulfonic acid group can be increased to improve proton conductivity because mechanical strength is not required to the proton conductive material. For example, JP-2003-263998-A has disclosed an electrolyte wherein a proton conducting polymer having an ion-exchange group such as —SO³— is filled in micropores in a porous base made of a polyimide or polyamide.

In the electrolyte membrane where a proton conductive material is filled in micropores in a porous polymer membrane having good mechanical strength, swelling with water is reduced so that a three dimensional structure of the polymer can be controlled to prevent an alcohol from penetrating. That is, crossover can be prevented, allowing a high concentration fuel to be employed.

Such a polymer electrolyte where a proton conductive material is filled in micropores in a porous membrane is a composite material. In an electrolyte membrane made of such a composite material, it is difficult to control the conditions such that the surface of the electrolyte membrane becomes flat while the proton conductive material is filled. Thus, there is a problem that its contact in an interface with a catalyst electrode layer is inadequate, often resulting in increase in a contact resistance.

JP-2001-294705-A has described that a porous membrane made of an aliphatic hydrocarbon polymer such as a polyolefin resin can be sulfonated in a vapor phase and then fused for closing holes to provide an electrolyte membrane. The membrane, however, does not exhibit satisfactory properties.

A direct type fuel cell can directly use a liquid fuel with a higher energy density in a fuel electrode. In contrast, a space for the use of a gaseous fuel or a reformer is needed in a gaseous fuel type fuel cell using a gaseous fuel including compressed gas or a reforming type fuel cell using a gaseous fuel made from the liquid fuel. A direct type fuel cell has been, therefore, being intensely studied because it can be made more compact than any of these types of fuel cells and is suitable for a small and portable fuel cell.

In a direct type fuel cell using a liquid as a fuel, a fuel electrode side is contiguous to a liquid phase while an air electrode side is contiguous to a gaseous phase. In the air electrode side, water generated by a chemical reaction during electric power generation and moving water penetrating an electrolyte membrane tend to prevent oxygen from moving in a gaseous phase in a diffusion layer in an air electrode. When the phenomenon is significant, it may cause reduction in a battery output, so-called “flooding”. To avoid the problem, it is desirable to make the air electrode side water-repellant for preventing moisture from becoming droplets to avoid interference with oxygen transfer.

On the other hand, the fuel electrode side contiguous to a liquid phase is desirably hydrophilic for promoting movement of an aqueous alcohol solution as a fuel, which then reacts with a fuel-electrode catalyst electrode to generate protons, and promoting transfer of the protons generated to an electrolyte membrane. Particularly, when a large current is discharged, i. e., when a large number of protons move, a more sufficiently hydrophilic environment is desired. In such a case, it is known that proton transfer is promoted when a catalyst layer is in close contact with an electrolyte membrane.

In the prior art, the above problems have been dealt by adding a hydrophilic or hydrophobic material to a catalyst electrode side, but it is not adequately effective.

### SUMMARY OF THE INVENTION

An objective of this invention is to provide a membrane electrode assembly comprising an electrolyte membrane having both excellent proton conductivity and excellent mechanical strength as well as good adhesiveness to a catalyst electrode layer, whereby a battery output can be improved, and a direct type fuel cell therewith.

According to an aspect of this invention, there is provided a membrane electrode assembly comprising a fuel electrode, an air electrode and an electrolyte membrane where micropores in a porous membrane is filled with a proton conducting polymer, wherein on at least one side of the electrolyte membrane is formed a planarizing layer, via which a fuel electrode or air electrode is formed.

In the membrane electrode assembly of this invention, in the air electrode side of the electrolyte membrane may be formed a hydrophobic membrane as the planarizing layer, via which an air electrode is formed.

In the membrane electrode assembly of this invention, in the fuel electrode side of the electrolyte membrane may be formed a hydrophilic membrane as the planarizing layer, via which a fuel electrode is formed.

In the membrane electrode assembly of this invention, in the air electrode side of the electrolyte membrane may be formed a hydrophobic film as the planarizing layer, via which an air electrode is formed, while in the fuel electrode side of the electrolyte membrane may be formed a hydrophilic film as the planarizing layer, via which a fuel electrode is formed.

In the membrane electrode assembly of this invention, it is preferable that the hydrophobic film is made of a hydrophobic organic material or a hydrophobic material comprising a composite of a carbon material and a hydrophobic organic material, and that the hydrophilic film is made of a hydrophilic material comprising an organic material having an ionic group.

In the membrane electrode assembly of this invention, the porous membrane is preferably made of a polymer material.

In the membrane electrode assembly of this invention, the porous membrane is preferably made of a material selected from a polyimide, a perfluorocarbon polymer and a polyolefin.

According to another aspect of this invention, there is provided a process for manufacturing the membrane electrode assembly described above, comprising the steps of forming the electrolyte membrane by introducing a polymerizable material comprising a monomer having a sulfonic acid group into micropores in the porous membrane for initiating a reaction of the monomer to form the proton conducting polymer for filling the micropores in the porous membrane; and forming a planarizing layer on at least one side of the electrolyte membrane.

In the process for manufacturing a membrane electrode assembly according to this invention, the monomer having a sulfonic acid group is preferably an acrylic monomer or olefinic monomer having a sulfonic acid group.

In the process for manufacturing a membrane electrode assembly according to this invention, a hydrophobic planarizing layer may be formed by applying a hydrophobic organic material or a hydrophobic material comprising a composite of a carbon material and a hydrophobic organic material to the air electrode side of the electrolyte membrane.

In the process for manufacturing a membrane electrode assembly according to this invention, a hydrophilic planarizing layer may be formed by applying a hydrophilic material comprising an organic material having an ionic group to the fuel electrode side of the electrolyte membrane.

According to another aspect of this invention, there is provided a direct type fuel cell comprising a membrane electrode assembly of this invention.

In this invention, a planarizing layer is formed on the surface of an electrolyte membrane in which a proton conducting polymer is filled in micropores in a porous membrane so that a membrane surface can be planarized to improve adhesiveness of a catalyst electrode layer to the electrolyte membrane. Application of a hydrophobic material to the membrane surface in the air electrode side can prevent penetration of water or droplet forming from water generated so that oxygen can be smoothly transferred. Furthermore, application of a hydrophilic material to the membrane surface in the fuel electrode side can improve ion conductivity. Owing to these effects, a direct type fuel cell with an improved output can be provided.

In other words, according to this invention, an electrolyte membrane in which micropores in a porous membrane are filled with a proton conducting polymer is used and a planarizing layer is formed between the electrolyte membrane and a catalyst electrode layer to improve adhesiveness between them. Thus, there can be provided a membrane electrode assembly having both adequate proton conductivity and adequate mechanical strength which allows a battery output to be improved, and a direct type fuel cell therewith. Furthermore, a hydrophilic film as a planarizing layer formed in a fuel electrode side can improve proton conductivity while a hydrophobic film as a planarizing layer formed in an air electrode can prevent flooding, allowing a battery output to be further improved.

### BRIEF DESCRIPTION OF THE DRAWINGS

FIG. 1 is a schematic cross-sectional view of a membrane electrode assembly according to this invention.

FIG. 2 is a schematic cross-sectional view of a membrane electrode assembly according to the prior art.

### DESCRIPTION OF THE PREFERRED EMBODIMENTS

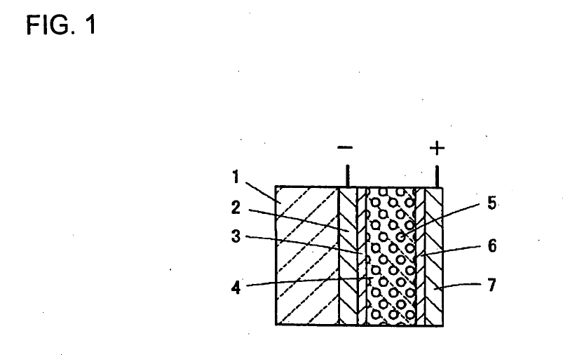

There will be described the most preferred embodiments of this invention with reference to the structure of a membrane electrode assembly (MEA) according to this invention illustrated in the drawing. FIG. 1 is a schematic cross-sectional view of a membrane electrode assembly (MEA) according to this invention. In this figure, 1 is an alcohol fuel, 2 is a fuel-electrode side catalyst layer, 3 is a hydrophilic material layer, 4 is a porous polymer membrane, 5 is a part filled with a proton conducting polymer, 6 is a hydrophobic material layer and 7 is an air-electrode side catalyst layer.

The MEA comprises, as an electrolyte membrane, a porous membrane filled with a proton conducting polymer. The sides of the electrolyte membrane comprise a hydrophilic material layer 3 and a hydrophobic material layer 6, respectively. Furthermore, a fuel-electrode side catalyst layer 2 (fuel electrode) and an air-electrode side catalyst layer (air electrode) are formed via the hydrophilic material layer 3 and the hydrophobic material layer 6, respectively.

A suitable porous membrane is a porous polymer membrane; for example, a porous membrane made of a nonionic polymer material including perfluorocarbon polymers such as polytetrafluoroethylene (PTFE), polyimides and polyolefins such as polyethylene. If necessary, these polymer materials can be used after hydrophilization by, for example, introducing a hydrophilic group. Among these, a porous membrane made of a perfluorocarbon polymer, particularly a hydrophilized PTFE porous membrane can be suitably used, but there are no particular restrictions to a material, a film thickness, porosity, hydrophilicity or hydrophobicity as long as a desired electrolyte membrane can be provided.

A proton conducting polymer filled in micropores in a porous membrane may be a polymer electrolyte having an ion exchange group such as a sulfonic acid group containing a proton which is readily released; for example, an acrylic or polyolefinic polymer electrolyte having an ion exchange group in its side chain.

A proton conducting polymer can be filled in micropores in a porous membrane by, for example, impregnating the porous membrane with a raw material solution containing a monomer having an ion exchange group and polymerizing the monomer as described below. Examples of a suitable monomer having an ion exchange group include an acrylic monomer having a sulfonic acid group and an olefinic monomer having a sulfonic acid group.

A raw material solution for producing a proton conducting polymer may consist of a monomer, a solvent and a radical polymerization initiator. The raw material solution may further contain a crosslinking agent and an additional copolymerizable monomer.

A porous membrane is impregnated with the raw material solution, which is then polymerized and dried. Then, the membrane is soaked in a washing liquid to remove unpolymerized materials and low-polymerized products. If necessary, the above process of impregnation and polymerization can be repeated, depending on a thickness and a porosity of the porous membrane and a filling rate of the proton conducting polymer.

On one side of the electrolyte membrane is applied a hydrophobic material to form a hydrophobic material layer in the air electrode side. A suitable hydrophobic material is a hydrophobic organic material, particularly a nonionic polymer compound. For example, a perfluorocarbon polymer such as PTFE can be used. The hydrophobic material may further contain a carbon material such as Ketjen Black and carbon black. As long as desired hydrophobicity is not deteriorated, a hydrophobic material layer may contain a catalyst for an air electrode for preventing flooding and also improving activity of an electrode reaction.

Catalysts may be a platinum-ruthenium (Pt—Ru) alloy catalyst in the fuel electrode side and a platinum (Pt) catalyst supported by Ketjen Black in the air electrode side. To a catalyst is added a hydrophilic polymer material solution such as a Nafion® solution and the mixture is stirred to provide a catalyst paste. The hydrophilic polymer material can constitute a hydrophilic material layer formed on the surface of the fuel electrode side and may be suitably a polymer compound having an ionic group such as a sulfonic acid group, for example a perfluorocarbon polymer having an ionic group such as a sulfonic acid group, typically a tetrafluoroethylene polymer having a sulfonic acid group in its side chain.

Then, to the fuel electrode side opposite to the air electrode side in the electrolyte membrane is applied a Pt—Ru catalyst paste to form a hydrophilic material layer. Thus, even when the porous membrane used itself has insufficient hydrophilicity, an interface between the electrolyte membrane and the fuel electrode can be made hydrophilic. Furthermore, since a smooth coating surface can be provided, adhesiveness between the electrolyte membrane and the fuel electrode can be improved. Although a Pt—Ru catalyst paste is herein used, a hydrophilic paste without a catalyst may be applied. As long as desired hydrophilicity is not deteriorated, the hydrophilic material layer preferably comprises a catalyst for a fuel electrode for improving activity of electrode reaction as well as proton conductivity.

Next, to current collectors for the fuel electrode and the air electrode are applied the Pt—Ru alloy catalyst paste and the Pt catalyst paste, respectively to give a fuel electrode and an air electrode.

An electrolyte membrane comprising the hydrophilic material layer and the hydrophobic material layer is sandwiched by these electrodes, and the product is heated under pressure for making the electrolyte membrane and the catalyst electrodes stick together to give an MEA.

The MEA obtained may be used according to a known technique to form a unit cell where an aqueous methanol solution is fed to a fuel electrode without pressure while air or oxygen is fed to an air electrode under, for example, an atmospheric pressure, or a combination of a plurality of such unit cells to give a direct type fuel cell of this invention.

### EXAMPLES

A process for manufacturing an MEA will be specifically described with reference to examples.

### Example 1

A porous membrane used was a hydrophilic PTFE porous membrane with a thickness of 25 μm.

An aqueous monomer solution as a raw material solution for a proton conducting polymer was prepared by mixing 6 g of acrylamide-tert-butylsulfonic acid as a monomer, 0.02 g of 2,2′-azobis-(2-amidinopropane).bishydrochloride as a radical initiator and 5 g of water.

The porous membrane was immersed in the aqueous monomer solution for 2 min to impregnate the micropores of the porous membrane with the aqueous monomer solution. The membrane was subjected to polymerization at 60° C. for 2 hours and then dried. Next, the membrane was immersed in warm water at 60° C. for washing to remove unpolymerized materials and low-polymerization products. The above process of impregnation, polymerization and washing was repeated twice.

To one side of the electrolyte membrane thus obtained was applied a 60% PTFE dispersion such that a resulting film has a thickness of 1 μm from the outermost part, to form a hydrophobic material layer in the air electrode side.

A platinum-ruthenium (Pt—Ru) alloy catalyst was prepared as a catalyst for the fuel electrode side while a platinum (Pt) catalyst supported by Ketjen Black was prepared as a catalyst for the air electrode side. Each of the catalysts was mixed with an equal amount of an alcohol solution of Nafion® to prepare a catalyst paste.

Then, to the fuel electrode side opposite to the air electrode side of the electrolyte membrane was applied the Pt—Ru catalyst paste to a film thickness of 1 μm, to form a hydrophilic material layer.

Next, to current collectors for the fuel electrode and for the air electrode were applied the Pt—Ru alloy catalyst paste and the Pt catalyst paste, respectively, to give a fuel electrode and an air electrode.

An electrolyte membrane comprising the hydrophilic material layer and the hydrophobic material layer was sandwiched by these electrodes, and the product was hot-pressed at 120° C. and 8.5 MPa for 2 min for making the electrolyte membrane and the electrodes stick together to form an MEA.

### Example 2

An MEA was prepared as described in Example 1, except that a hydrophilic material layer was not formed in the electrolyte membrane.

### Example 3

An MEA was prepared as described in Example 1, except that a hydrophobic material layer was not formed in the electrolyte membrane.

### Conventional Example

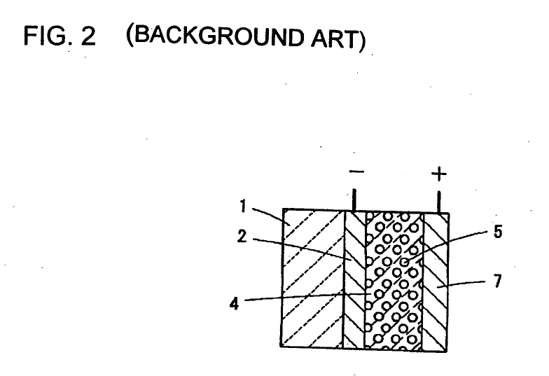

An MEA was prepared as described in Example 1, except that hydrophobic and hydrophilic material layers were not formed in the electrolyte membrane. This corresponds to the conventional example in FIG. 2.

Each of the MEAs in Examples 1 to 3 and Conventional Example was used to make a unit cell configured that a 10 vol % aqueous methanol solution was fed to a fuel electrode without pressure and air was in contact with an air electrode under an atmospheric pressure. Its electric properties were evaluated by determining output values at 25° C. and 5° C. and a discharge time. The results are shown in Table 1.

TABLE 1

| | Maximum output at | Maximum output at | Discharge time | |
|---|---|---|---|---|
| | 25° C. (mW/cm²) | 5° C. (mW/cm²) | at 5° C. | |
| Example 1 | 28 | 12 | ≧180 | min |
| Example 2 | 23 | 10 | 120 | min |
| Example 3 | 25 | 9 | 110 | min |
| Conventional | 20 | 7 | 90 | min |
| Example | | | | |

As seen from the measurement results of the maximum output at 25° C., the output of Example 1 was most improved because of improvement in adhesiveness and hydrophobicity in the oxygen electrode side and improvement in adhesiveness and hydrophilicity in the fuel electrode side. The results also show that Examples 2 and 3 gave a higher output than Conventional Example because of improvement in adhesiveness and hydrophobicity in the oxygen electrode side and improvement in adhesiveness and hydrophilicity in the fuel electrode side, respectively.

As seen from the measurement results at 5° C., any of Examples 1 to 3 exhibited good output and discharge properties. In particular, Example 1 gave particularly improved output and discharge properties. It was because in comparison with Conventional Example, improved adhesiveness between the electrolyte membrane and the electrodes resulted in an increased output and increased catalyst activity, which led to a higher auto-oxidation heating temperature of the catalyst so that water generated by the fuel cell reaction was more easily vaporized and a less amount of water penetrated from the electrolyte membrane, resulting in prevention of flooding.

In the above examples, an acrylic monomer having a sulfonic acid group was radical-polymerized in micropores in a porous membrane to form a proton conducting polymer filling the micropores in the porous membrane. Alternatively, an acrylic monomer having a sulfonic acid group and another acrylic monomer may be co-polymerized in micropores in a porous membrane to form a proton conducting polymer filling the micropores in the porous membrane.

Furthermore, an olefin such as ethylene having a sulfonic acid group as a substituent may be polymerized in micropores in a porous membrane to form a proton conducting polymer filling the micropores in the porous membrane. Alternatively, an olefin such as ethylene having a sulfonic acid group as a substituent and another olefin may be co-polymerized in micropores in a porous membrane to form a proton conducting polymer filling the micropores in the porous membrane.

1. A membrane electrode assembly comprising a fuel electrode, an air electrode and an electrolyte membrane where micropores in a porous membrane is filled with a proton conducting polymer, wherein on at least one side of the electrolyte membrane is formed a planarizing layer, via which a fuel electrode or air electrode is formed.

2. The membrane electrode assembly as claimed in claim 1, wherein in the air electrode side of the electrolyte membrane is formed a hydrophobic film as the planarizing layer, via which an air electrode is formed.

3. The membrane electrode assembly as claimed in claim 1, wherein in the fuel electrode side of the electrolyte membrane is formed a hydrophilic film as the planarizing layer, via which a fuel electrode is formed.

4. The membrane electrode assembly as claimed in claim 1, wherein in the air electrode side of the electrolyte membrane is formed a hydrophobic film as the planarizing layer, via which an air electrode is formed, while in the fuel electrode side of the electrolyte membrane is formed a hydrophilic film as the planarizing layer, via which a fuel electrode is formed.

5. The membrane electrode assembly as claimed in claim 2, wherein the hydrophobic film is made of a hydrophobic organic material or a hydrophobic material comprising a composite of a carbon material and a hydrophobic organic material.

6. The membrane electrode assembly as claimed in claim 3, wherein the hydrophilic film is made of a hydrophilic material comprising an organic material having an ionic group.

7. The membrane electrode assembly as claimed in claim 1, wherein the porous membrane is made of a polymer material.

8. The membrane electrode assembly as claimed in claim 1, wherein the porous membrane is made of a material selected from a polyimide, a perfluorocarbon polymer and a polyolefin.

9. A process for manufacturing the membrane electrode assembly as claimed in any of claims 1 to 8, comprising the steps of:
forming the electrolyte membrane by introducing a polymerizable material comprising a monomer having a sulfonic acid group into micropores in the porous membrane for initiating a reaction of the monomer to form the proton conducting polymer for filling the micropores in the porous membrane; and
forming a planarizing layer on at least one side of the electrolyte membrane.

10. The process for manufacturing a membrane electrode assembly as claimed in claim 9, wherein the monomer having a sulfonic acid group is an acrylic monomer or olefinic monomer having a sulfonic acid group.

11. The process for manufacturing a membrane electrode assembly as claimed in claim 9, wherein a hydrophobic planarizing layer is formed by applying a hydrophobic organic material or a hydrophobic material comprising a composite of a carbon material and a hydrophobic organic material to the air electrode side of the electrolyte membrane.

12. The process for manufacturing a membrane electrode assembly as claimed in claim 9, wherein a hydrophilic planarizing layer is formed by applying a hydrophilic material comprising an organic material having an ionic group to the fuel electrode side of the electrolyte membrane.

13. A direct type fuel cell comprising the membrane electrode assembly as claimed in any of claims 1 to 8.
